(19) United States
(12) Patent Application Publication
(10) Pub. No.: US 2015/0334209 A1
(43) Pub. Date: Nov. 19, 2015

(54) METHOD FOR TRANSMITTING PACKET IN LOW POWER WIRELESS NETWORK

(71) Applicant: ELECTRONICS AND TELECOMMUNICATIONS RESEARCH INSTITUTE, Daejeon (KR)

(72) Inventor: Jun Keun SONG, Daejeon (KR)

(21) Appl. No.: 14/689,684

(22) Filed: Apr. 17, 2015

(30) Foreign Application Priority Data
May 13, 2014 (KR) 10-2014-0057275

(51) Int. Cl. H04L 29/06; H04L 12/863; H04L 1/16; H04W 72/04; H04W 72/00

(52) U.S. Cl. CPC H04L 69/22; H04W 72/0473; H04W 72/005; H04L 1/1685; H04L 69/163; H04L 47/626

(57) ABSTRACT

Provided herein is a packet transmitting method in a low power wireless network, the method including receiving, by a node, packets from nodes on both sides of the node; performing a network coding on the received packets; and transmitting the network coded packets to the nodes on both sides of the node.

### CROSS-REFERENCE TO RELATED APPLICATION

The present application claims priority to Korean patent application number 10-2014-0057275, filed on May 13, 2014, the entire disclosure of which is incorporated herein in its entirety by reference.

### BACKGROUND

1. Field of Invention

Various embodiments of the present invention relate to a wireless network system, and more particularly, to a packet transmitting method capable of reducing a bandwidth in a low power wireless network.

2. Description of Related Art

As application fields such as IOTs (Internet of Things) and smart grids gather attention, demand for low power and lossy networks (hereinafter referred to as ‘LLN’) is increasing.

The ROLL (Routing Over Low power Lossy network) WG (Working Group) of the IETF (Internet Engineering Task Force) determined that it was difficult to apply the existing Mobile Ad hoc Network (hereinafter referred to as ‘MANET’) routing protocol to LLNs. Thus, it announced the Routing Protocol LLN (hereinafter referred to as ‘RPL’) that has its basis on Internet Protocol version 6 (hereinafter referred to as ‘IPv6’). Furthermore, Zigbee Alliance announced the Zigbee IP standard that uses the IPv6 address system while complying with the IEEE 802.15.4 standard.

Recently, there have been increasing attempts to embody WOTs (Web of Things) in an IPv6 based network, and the Zigbee IP standard adopted the TCP (Transmission Control Protocol) and the HTTP (Hypertext Transfer Protocol) as standards for transmitting application data.

However, the TCP (Transmission Control Protocol) that is mainly used in wired environments is not suitable for usage in an LLN. In order to obtain reliability, a transmission between an End-to-End (hereinafter referred to as ‘E2E’) needs to be checked, and due to the IEEE802.15.4 standard, there are limitations to the wireless bandwidth of transmitting only data of up to 127 bytes.

As such, it is possible to transmit a packet using an internet protocol (for example, the TCP) in a wireless network that uses low power (for example, 6LoWPAN: IPv6 Low-power Wireless Personal Area Network).

Herein, when there is a loss of packet in a low power wireless network, the packet needs to be re-transmitted, and when the number of hops between two nodes increases, a bandwidth would be wasted even more, which is a problem.

### SUMMARY

A purpose of various embodiments of the present invention is to provide a packet transmitting method capable of reducing a bandwidth in a low power wireless network.

Another purpose of various embodiments of the present invention is to provide a packet transmitting method capable of reducing the number of times of transmitting a packet in a low power wireless network.

Another purpose of various embodiments of the present invention is to provide a packet transmitting method capable of quickly re-transmitting a packet when there is a need to re-transmit the packet in a low power wireless network, and also minimizing the need for re-transmission.

According to an embodiment of the present invention, there is provided a packet transmitting method in a low power wireless network, the method including receiving, by a node, packets from nodes on both sides of the node; performing a network coding on the received packets; and transmitting the network coded packets to the nodes on both sides of the node.

Herein, the method may further include storing, by the node, the packets transmitted to the nodes on both sides of the node.

Herein, the performing a network coding may include receiving an ACK packet for checking a nonreceived packet from one of the nodes on both sides of the node; and network coding a packet corresponding to the nonreceived packet of among the stored packets, and the ACK packet.

Herein, the network coding may be performed when repeatedly receiving the ACK packet.

Herein, the method may further include, after the receiving of packets, enqueuing a packet of an upstream direction in an upstream queue, and enqueuing a packet of a downstream direction in a downstream queue, according to a transmission direction of the packet.

Herein, each of the upstream queue and the downstream queue may include a first queue where packets to be transmitted are stored, a second queue where packets that have been transmitted are stored, and a third queue where on-hold packets for retransmission are stored.

Herein, the node may transmit the received packet to the first queue, second queue, and third queue, successively.

Herein, the upstream queue may represent the direction of data flow from a border router to a node, and the downstream queue may represent the direction of data flow from the node to the border router, in the low power wireless network.

Herein, the packet may be a TCP (Transmission Control Protocol) packet.

Herein, the method may further include driving a forward timer for on-holding the packet transmission for a predetermined on-hold time if there does not exist a packet for a network coding.

Herein, the on-hold time may be the same or longer than a delayed ACK time of the TCP (Transmission Control Protocol).

Herein, the on-hold time may be predetermined considering an RTT (Round Trip Time) of the packet and the number of hops between E2E nodes.

A method for transmitting a packet according to the aforementioned embodiments of the present invention is capable of reducing a bandwidth in a network having a limited bandwidth by transmitting a packet that needs to be re-transmitted in a low power wireless network through network coding. In such a packet transmitting method, network coding is performed on a node that is near a node that has not received a packet, thereby reducing the number of times of transmitting a packet. Thus, when there is a need to re-transmit a packet, the proposed packet transmitting method may perform a re-transmission quickly and minimize demand for re-transmission.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a view illustrating a network system according to an embodiment of the present invention;

FIG. 2 is a view illustrating a wireless transmission area through nodes based on a border router according to an embodiment of the present invention;

FIG. 3 is a view illustrating a network coding according to an embodiment of the present invention;

FIG. 4 is a signal flowchart illustrating a general failure in transmitting a packet;

FIG. 5 is a signal flowchart illustrating a packet transmitting operation using a network coding according to an embodiment of the present invention;

FIG. 6 is a flowchart illustrating a packet transmitting operation according to an embodiment of the present invention;

FIGS. 7A and 7B are flowcharts illustrating a packet receiving operation according to an embodiment of the present invention;

FIG. 8 is a view illustrating packet queues of a node according to an embodiment of the present invention; and

FIG. 9 is a flowchart illustrating a network coding operation according to an embodiment of the present invention.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’, and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected’ represents that one component is directly connected to another component or indirectly connected through another component. In this specification, a singular form may include a plural form as long as it is not specifically mentioned in a sentence.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

The present invention may provide a packet transmitting method capable of reducing a bandwidth using a network coding in a network having a limited bandwidth such as a low power wireless network. Herein, a low power wireless network refers to an IPv6 Low power Wireless Personal Area Network (hereinafter referred to as ‘6LoWPAN’), but the present invention may be applied to other low power wireless networks as well.

Herein, it is to be assumed that a 6LoWPAN is a Routing Protocol LLN (hereinafter referred to as ‘RPL’) environment that has its basis on Internet Protocol version 6 (hereinafter referred to as ‘IPv6’).

Herein, it is to be assumed that a network consisting of a plurality of terminals has its basis on the IEEE802.15.4, and the network may simultaneously transmit up to 127 bytes of data in a maximum bandwidth of 250 kbps. In order to use the IPv6 in the IEEE802.15.4, a 6LoWPAN is used as an adaptation layer, and an RPL is used as a routing protocol in the IPv6. Therefore, taking into account the control packets of the RPL in the IEEE802.15.4, the bandwidth of the network would be limited.

FIG. 1 is a view illustrating a network system according to an embodiment of the present invention.

Referring to FIG. 1, the network system includes the interne 101 and a low power wireless network 102. Herein, the low power wireless network 102 may access the interne 101 through a BR (Border Router, 120).

The interne 101 includes a computer 110 connected thereto. The internet 101 may use the Internet Protocol version 6 (hereinafter referred to as ‘IPv6’) as an address system for differentiating the computer 110.

The low power wireless network 102 is an IPv6/RPL network that has its basis on a 6LoWPAN. The low power wireless network 102 includes a plurality of nodes 131, 132, 133, 134, 135, 136, 137 that are connected based on the border router 120 and communicate with one another. The plurality of nodes 131, 132, 133, 134, 135, 136, 137 communicate wirelessly. Herein, the border router 120 may be a 6BR (6LoWPAN Border Router). In the case of an RPL, a communication path between the border router 120 and the nodes 131, 132, 133, 134, 135, 136, 137 may be modified according to changes in a matrix. However, it is to be assumed that an upstream path and a downstream path are the same at any point.

Therefore, in order to be connected to an external network, the low power wireless network 102 performs communication through the border router 120. For example, the border router 120 includes a 6 BR (6LoWPAN Border Router).

An E2E communication 140 may be made between terminals (for example, between the computer 110 and the node 137) through the border router 120.

Meanwhile, the TCP (Transmission Control Protocol) is a communication protocol having a two-way connection, which performs an E2E (End to End) communication between two terminals. Such a TCP requires checking of a transmitted message for a reliable data transmission. Thus, even though data is actually transmitted bilaterally, a two-way traffic is generated unlike in the UDP (User Data Protocol).

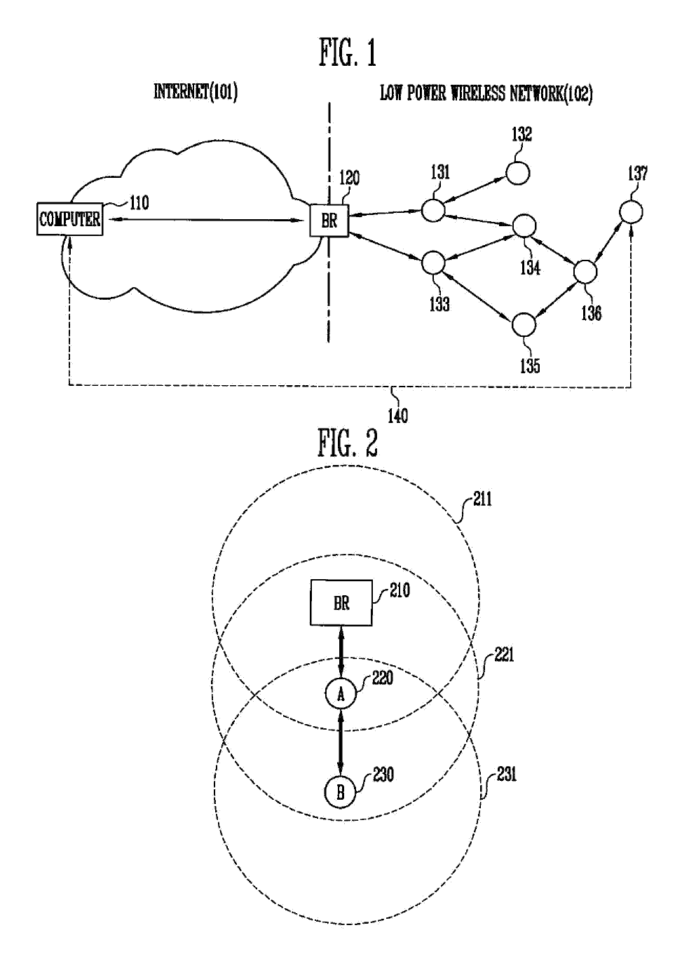

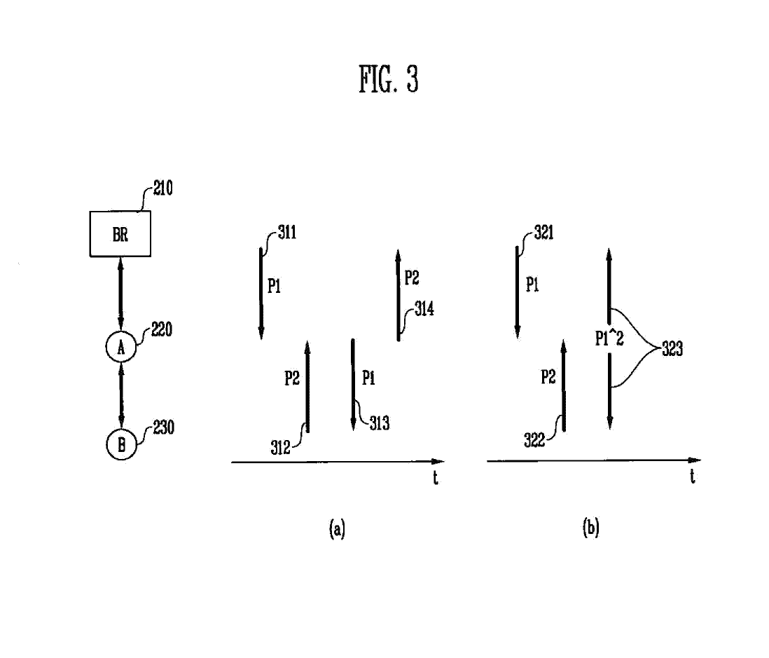

FIG. 2 is a view illustrating a wireless transmission area through nodes based on a border router according to an embodiment of the present invention.

Referring to FIG. 2, based on the border router 210, a first node 220 is located, and a second node 230 is located farther from the border router 210 than the first node 220.

Herein, the border router 210 forms a first wireless transmission area 211 centered around the border router 210. Since the first wireless transmission area 211 may influence the first node 220, the border router 210 may communicate with the first node 220.

The first node 220 forms a second wireless transmission area 221 centered around the first node 220. Since the second wireless transmission area 221 may influence the border router 210 and the second node 230, the first node 220 may communicate with the border router 210 and the second node 230.

The second node 230 forms a third wireless transmission area 231 centered around the second node 230. Since the third transmission area 231 may influence the first node 220, the second node 230 may communicate with the first node 220.

Therefore, when the border router 210 and the second node 230 transmits a packet (i.e. data) at the same time, a hidden node terminal problem may occur where the first node 220 cannot receive the packet in a normal way.

Hereinbelow, a packet flow being transmitted from the border router 210 to a destination node is to be defined as downstream, and a packet flow being transmitted from a destination node to the border router 210 is to be defined as upstream.

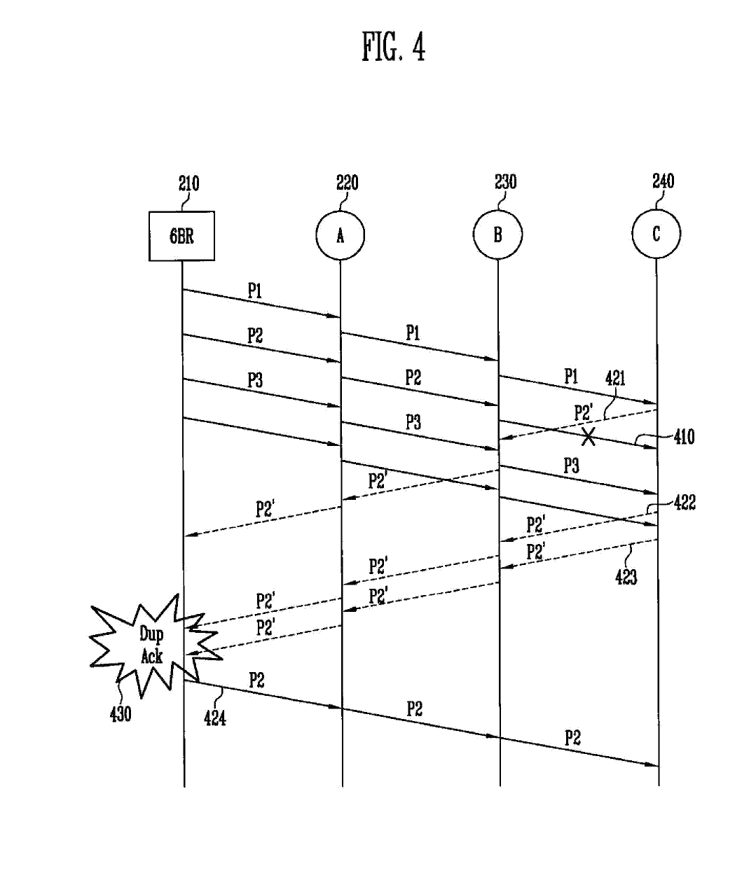

FIG. 3 is a view illustrating a network coding according to an embodiment of the present invention.

Referring to FIG. 3, a border router 210 and nodes 220, 230 may transmit a packet (or segment) to each other.

The border router 210 may transmit a first packet P1 to the second node 230, and the second node 230 may transmit a second packet P2 to the border router 210.

(a) illustrates a general packet transmission, and (b) illustrates a packet transmission using a network coding.

In (a), the border router 210 transmits a first packet P1 to be transmitted to the second node 230 to the first node 220 (step 311).

Furthermore, the second node 230 transmits a second packet P2 to be transmitted to the border router 210 to the first node 220 (step 312).

The first node 220 transmits the first packet P1 to the second node 230 (step 313).

The first node 220 transmits the second packet P2 to the border router 210 (step 314).

As such, in the case of a general packet transmission, four packet transmissions are needed between the border router 210, first node 220, and second node 230.

In (b), the border router 210 transmits a first packet P I to be transmitted to the second node 230 to the first node 220 (step 321).

Furthermore, the second node 230 transmits a second packet P2 to be transmitted to the border router 210 to the first node (step 322).

Herein, the first node 220 performs a network coding on the first packet P1 and the second packet P2. The first node 220 transmits the packet P1̂2 that has been network coded to the border router 210 and the second node 230 at once (step 323). The border router 210 and the second packet 230 that received the network coded packet P1̂2 each knows the packet that it transmitted. Therefore, the border router 210 and the second node 230 that received the network coded packet P1̂2 each uses the packet that it transmitted to decode the network coded packet P1̂2. Through this process, the border router 210 may receive the second packet P2, and the second node 230 may receive the first packet P1.

For example, a 6LoWPAN uses a limited bandwidth. Thus, when a TCP packet is lost, in a multi-hop environment, all nodes must re-transmit through an End-to-End (E2E) transmission. This may have a significant effect on the condition of the entire network, and thus, a transmission in a conventional wireless environment in a multi-hop wireless environment may cause another problem.

Therefore, by storing a transmission packet for a network coding when using the TCP in an IPv6/RPL environment that is based on a 6LoPAN through an approach of a cross-layer, it is possible to effectively use a bandwidth of the entire network

As such, performing a network coding in the TCP means storing a packet (or segment) for decoding. For example, in order to receive a network coded packet P1̂2 normally, the border router 210 must be storing the first packet P1 transmitted in a downstream direction, and the second node 230 must be storing the second packet P2 transmitted in an upstream direction.

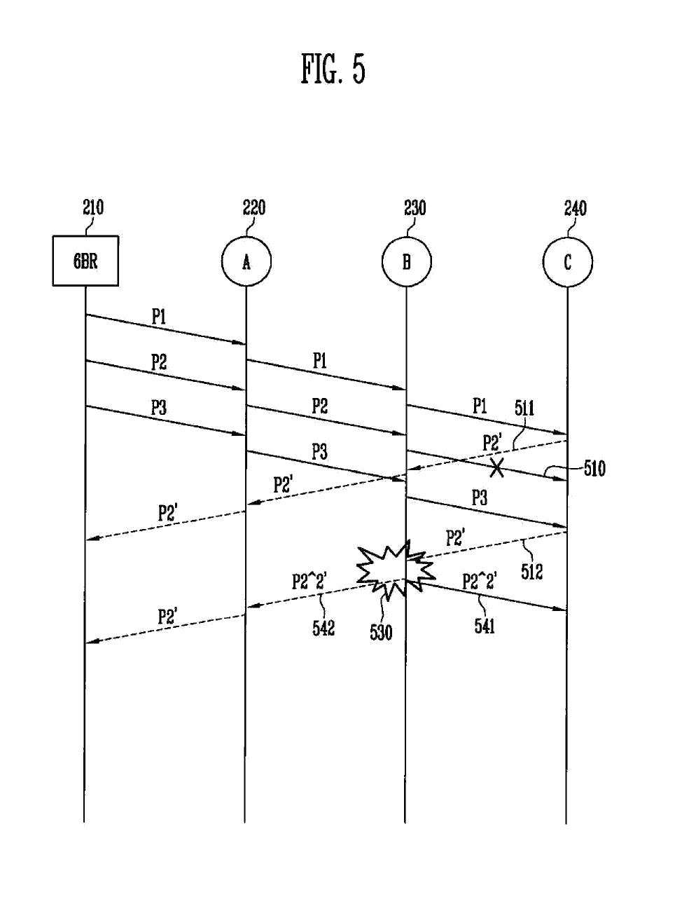

FIG. 4 is a signal flowchart illustrating a failure of a normal packet transmission.

FIG. 4 illustrates a TCP transmission between the border router 210 and the nodes 220, 230, 240.

The border router 210 successively transmits packets P1, P2, P3, . . . to the third node 240. The border router 210 transmits the first packet P1 to the third node 240 through the first node 220 and second node 230.

Then, the border router 210 transmits the second packet P2 to the third node 240 through the first node 220 and the second node 230. Herein, when the second packet (P2) is transmitted from the second node 230 to the third node 240, the second packet P2 is lost (step 410).

In a TCP transmission, when a normal packet is received, a sequence number of the packet to be received next is transmitted through an ACK (acknowledge) field of a header. However, when the transmission of a second packet P2 fails, the third node 240 transmits the same sequence number P2′ (for example, the sequence number of the second packet P2) to the border router 210 through the second node 230 in order to show that the second packet P2 is lost (steps 421, 422, 423).

In the case of a retransmission timeout (hereinafter referred to as ‘RTO’) (when an ACK is not received within an RTO time) or when a same ACK packet is received repeatedly (steps 421, 422, 423) (step 430), it may be regarded that data has been lost.

The border router 210 performs a retransmission by an ACK packet (step 424). That is, in the case where successive streaming data is transmitted, the border router 210 first performs a retransmission by a repeated ACK packet. In such a case, in a multi-hop environment, transmission of a repeated packet increases.

FIG. 5 is a signal flowchart illustrating a packet transmission operation using a network coding according to an embodiment of the present invention.

FIG. 5 illustrates a TCP transmission between the border router 210 and the nodes 220, 230, 240.

The border router 210 successively transmits packets P1, P2, P3, . . . to the third node 240. The border router 210 transmits the first packet P1 to the third node 240 through the first node 220 and the second node 230.

Then, the border router 210 transmits the second packet P2 to the third node 240 through the first node 220 and the second node 230. Herein, when the second packet P2 is being transmitted from the second node 230 to the third node 240, the second packet P2 may be lost (step 510).

As such, when the transmission of the second packet P2 fails, the third node 240 transmits the same sequence number P2′ (for example, the sequence number of the second packet P2) to the second node 230 in order to show that the second packet P2 is lost (step 511, step 512).

When a nonreceived packet P2′ that shows that a packet has been lost is received repeatedly (step 530), the second, node 230 performs, a network coding on the nonreceived packet P2′ and the second packet P2. The second node 230 transmits the network coded packet P2̂2′ to the first node 220 and the third node 240 at the same time (step 541, step 542).

When the third node 240 receives the network coded packet P2̂2′ it decodes it with the nonreceived packet P2′ that it transmitted and receives the second packet P2.

The border router 210 receives the nonreceived packet P2′, but since it is processed in the second node 230, it does not further receive a repeated ACK packet, and thus a retransmission is not performed.

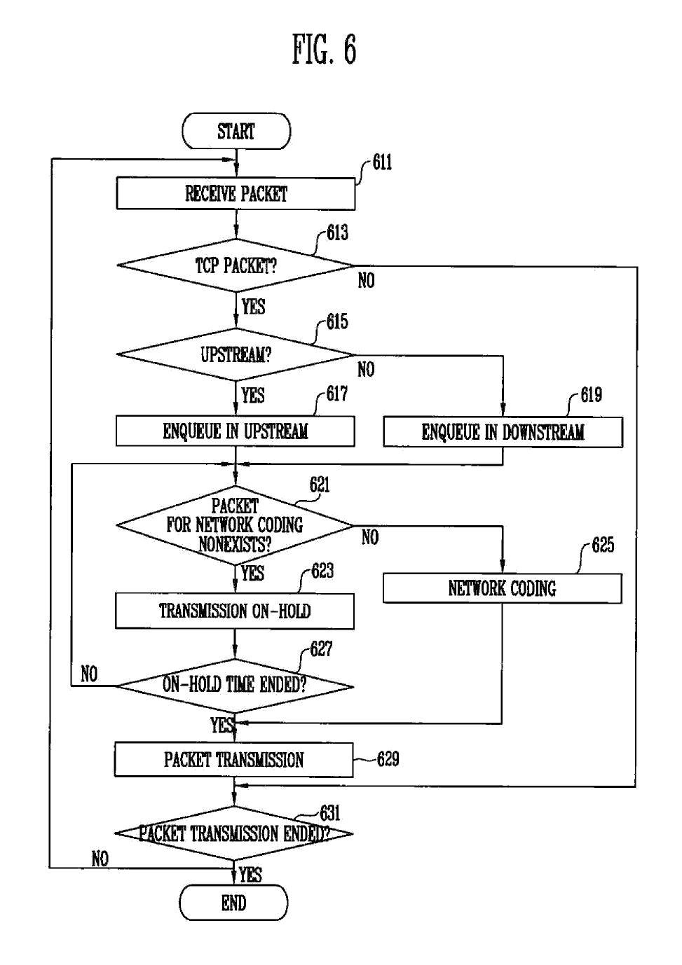

FIG. 6 is a flowchart illustrating a packet transmission operation according to an embodiment of the present invention.

Referring to FIG. 6, a node receives a packet (step 611).

The node that received the packet determines whether or not the received packet is a TCP packet (step 613). If it is determined that the received packet is a TCP packet as a result of step 613, the node proceeds to step 615. However, if it is determined that the received packet is not a TCP packet as a result of step 613, the node proceeds to step 633. Herein, the node performs a packet processing operation that corresponds to the packet.

The node determines whether or not the received packet is an upstream packet (step 615). Herein, upstream represents a packet flow in the direction from the node to the border router.

If it is determined that the received packet is an upstream packet as a result of step 615, the node proceeds to step 617.

The node enqueues the received packet in an upstream direction and proceeds to step 621 (step 617).

However, if it is determined that the received packet is not an upstream packet as a result of step 615, the node proceeds to step 619. In such a case, the received packet is a downstream packet, and the downstream packet represents a packet flow in the direction from the border router to the node.

The node enqueues the received packet in a downstream direction and proceeds to step 621 (step 619).

The node checks whether or not there does not exist a packet to be transmitted in an opposite stream direction for a network coding (step 621).

If it is determined that there does not exist a packet to be transmitted in an opposite stream direction as a result of step 621, the node proceeds to step 623.

The node on-holds packet transmission for a predetermined time by driving a forward timer provided inside (step 623). Herein, the node on-holds the packet transmission for a predetermined on-hold time for a network coding. Herein, the on-hold time may be the same or longer than a delayed ACK time, and may be determined considering the RTT (Round Trip Time) of the packet and the number of hops between E2E nodes. Herein, if there exists a packet in an upstream direction or downstream direction to be transmitted, the node ends the on-hold operation (for example, ends the forward timer).

The node determines whether or not the on-hold time for packet transmission has ended by checking whether or not the forward timer has ended (step 627).

If it is determined that the on-hold time has ended as a result of step 627, the node proceeds to step 629. However, if it is determined that the on-hold time has not ended as result of step 627, the node proceeds to step 621.

Meanwhile, if it is determined that there exists a packet to be transmitted in an opposite stream direction as a result of step 621 (that is, if there exists a packet for a network coding), the node proceeds to step 625.

The node performs a network coding with the packet to be transmitted in the opposite stream direction and proceeds to step 629 (step 625).

The node transmits the received packet or transmits the network coded packet (step 629).

The node checks whether or not the packet transmission has ended (step 631). If it is determined that the packet transmission has ended as result of step 631, the node ends the packet transmission operation. However, if it is determined that the packet transmission has not ended as a result of step 631, the nodes proceeds to step 611 and may receive the next packet.

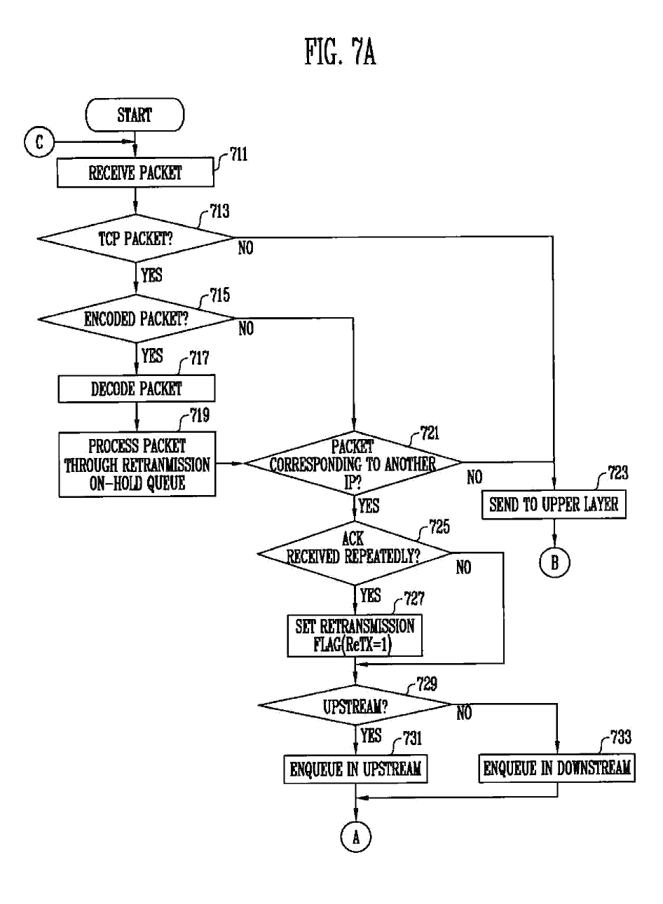

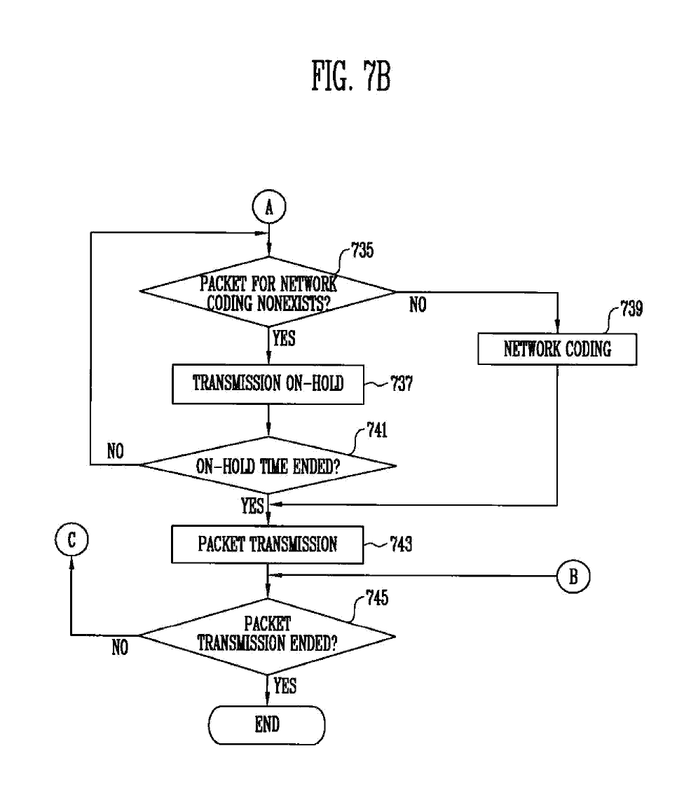

FIGS. 7A and 7B are flowcharts illustrating a packet receiving operation according to an embodiment of the present invention.

Referring to FIGS. 7A and 7B, a node receives a packet (step 711).

The node that received the packet determines whether or not the received packet is a TCP packet (step 713). If it is determined that the received packet is a TCP packet as a result of step 713, the node proceeds to step 715. However, if it is determined that the received packet is not a TCP packet as a result of step 713, the node proceeds to step 723. Herein, the node performs a packet processing operation corresponding to the packet.

The node checks whether or not the received TCP packet is a packet encoded through a network coding (step 715).

If it is determined that the received packet is an encoded packet as a result of step 715, the node proceeds to step 717. Meanwhile, if it is determined that the received packet is not an encoded packet as a result of step 715, the node proceeds to step 721.

The node decodes the received packet (step 717). The node decodes the packet to be received from the network coded packet using the packet that it transmitted.

The node stores the decoded packet in a retransmission on-hold queue (step 717). The packet stored in the retransmission on-hold queue is deleted after a certain period of time. For this purpose, the node may use a timer for deleting the packet stored in the retransmission on-hold queue.

The node determines whether or not the packet corresponds to an internet protocol (hereinafter referred to as ‘IP’) of another node (step 721). That is, the node determines whether or not the received packet or the packet decoded from the received packet is a packet to be transmitted to another node (destination) (for example, whether or not it has an internet protocol address of another node).

If it is determined that the packet is a packet corresponding to a node having another IP as a result of step 721, the node proceeds to step 725. However, if it is determined that the received packet is a packet corresponding to it's IP as a result of step 721, the node proceeds to step 723.

The node sends the packet corresponding to it's 1P to an upper layer and proceeds to step 745 (step 723).

The node checks whether or not an ACK packet has been received repeatedly (step 725). Herein, the node examines whether or not it received an ACK packet repeatedly by comparing with a latest received ACI(packet, when forwarding the packet.

If it is checked that it received an ACK packet repeatedly at step 725, the node proceeds to step 727.

The node sets a retransmission flag (step 727). Herein, the node sets the retransmission flag to 1 (RetX=1). Such a setting of a retransmission flag is for retransmission through a cross layer approach.

However, if it is checked that the node did not receive an ACK packet repeatedly at step 725, the node proceeds to step 729.

The node determines whether or not the received packet is an upstream packet (step 729).

If it is determined that the received packet is an upstream packet as a result of step 729, the node proceeds to step 731.

The node enqueues the received packet in an upstream direction and proceeds to step 735 (step 731).

However, if it is determined that the received packet is not an upstream packet as a result of step 729, the node proceeds to step 733. In such a case, it means that the received packet is a downstream packet, and the downstream represents a packet flow in the direction from the border router to the node.

The node enqueues the received TCP packet in a downstream direction, and proceeds to step 735 (step 733).

The node checks whether or not there does not exist a packet to be transmitted in an opposite stream direction for a network coding (step 735).

If it is determined that there exists a packet to be transmitted in an opposite stream direction as a result of step 735, the node proceeds to step 739.

If it is determined that there does not exist a packet to be transmitted in an opposite stream direction as a result of step 735, the node proceeds to step 737.

The node on-holds the packet transmission for a predetermined time by driving a forward timer provided inside (step 737). Herein, the node on-holds the packet transmission for a network coding for a predetermined time. Herein, the on-hold time is the same or longer than the delayed ACK time, and may be set considering the RTT (Round Trip Time) of the packet and the number of hops between the E2E nodes. Herein, if there exists a packet in an upstream direction or downstream direction to be transmitted, the node ends the on-hold operation (for example, ends the forward timer).

The node checks whether or not the on-hold time for packet transmission has ended by checking whether or not the forward timer has ended (step 741).

If it is determined that the on-hold time has ended as a result of step 741, the node proceeds to step 743. However, if it is determined that the on-hold time has not ended as a result of step 741, the node proceeds to step 735.

Meanwhile, if it is determined that there exists a packet to be transmitted in an opposite stream direction (that is, if there exists a packet for a network coding) as a result of step 735, the node proceeds to step 739.

The node performs a network coding with the packet to be transmitted in the opposite stream direction and proceeds to step 743 (step 739).

The node transmits the received packet or transmits the network coded packet (step 743).

The node checks whether or not the packet transmission has ended (step 747). If it is determined that the packet transmission has ended as a result of step 747, the node ends the packet transmission operation. However, if it is determined that the packet transmission has not ended as a result of step 747, the node proceeds to step 711 and may receive the next packet.

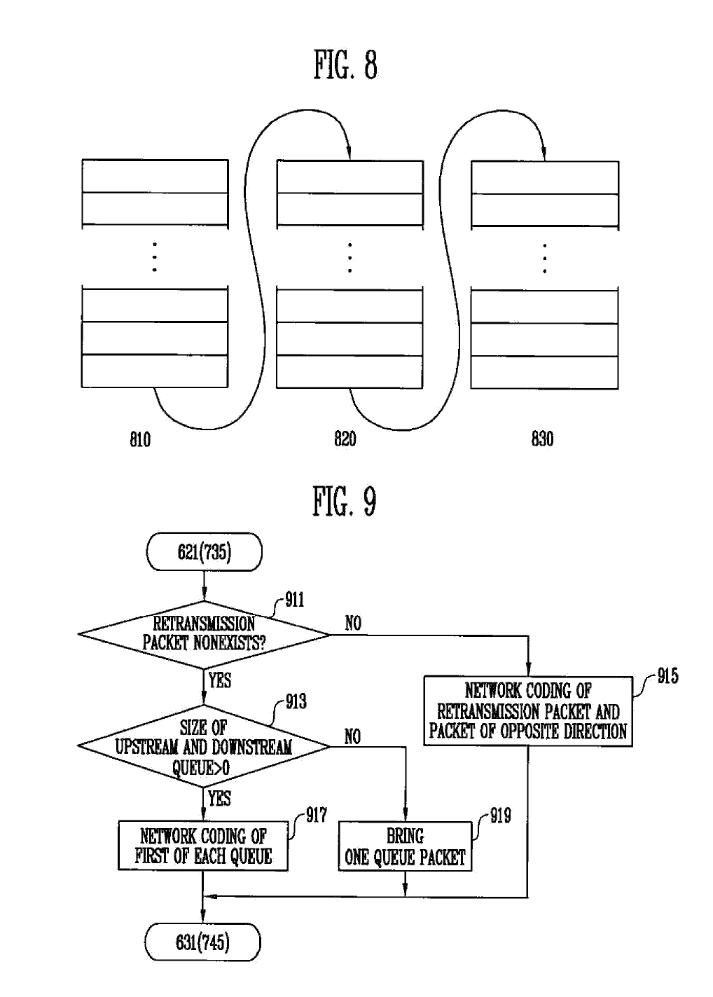

FIG. 8 is a view illustrating a packet queue of a node according to an embodiment of the present invention.

Referring to FIG. 8, for one connection, the node generates a queue for packet to be sent 810, a queue for packet that is, sent 820, and a retransmission on-hold packet queue 830. Herein, for one connection, there is a packet for two streams (upstream+downstream). Therefore, for one connection, two packet queue sets (that is, two queues for packet to be sent 810, two queues for packet that is sent 820, and two retransmission packet queues 830 exist) are formed for two streams.

The queue for packet to be sent 810 is a queue where a packet to be transmitted to another node is stored. When the forward timer ends, the node sends the packet stored in the queue for packet to be sent 810 to another node through a lower layer. Herein, when a network coding is necessary, the node performs a network coding on the packet stored in the queue for packet to be sent 810 and the packet stored in the retransmission on-hold packet queue 830 and sends the result to another node through a lower layer.

Then, the node stores an original packet of the packet that has been transmitted in the queue for packet that is sent 820. Herein, in the queue for packet that is sent 820, a packet for decoding a network coded packet is stored.

When a network coded packet is received, the node decodes the packet using the packet stored in the queue for packet that is sent 820. As such, since there will no case of receiving the decoded packet again, the node moves the decoded packet to the retransmission on-hold queue 830.

The retransmission on-hold queue 830 is used for a quick retransmission by approaching of a cross layer. After a certain period of time, regarding that a re-transmission is not necessary, it deletes the packet.

As such, the node may move a received packet to the queue for packet that is sent 810, to the queue for packet to be sent 820, and to the retransmission on-hold packet queue 830, successively.

FIG. 9 is a flowchart illustrating a network coding operation according to an embodiment of the present invention.

Referring to FIG. 9, the node determines whether or not a retransmission packet exists (step 911). Herein, the node determines at the same time whether or not the retransmission flag (ReTx) is 1. Herein, step 911 may be performed after step 621 (or step 735). Otherwise, step 911 may be performed after the operating time of the forward timer has ended.

If it is determined that there does not exist a retransmission packet and the retransmission flag (ReTx) is not 1 as a result of step 911, the node proceeds to step 913.

The node checks whether or not a size of the queue of the upstream and downstream is bigger than 0 (step 913).

If it is determined that the size of the queue of the upstream and downstream is bigger than 0 as a result of step 913, the node proceeds to step 917.

The node performs a network coding on first packets of each queue and proceeds to step 631 (or step 745).

However, if it is determined that the size of the queue of the upstream or downstream is not bigger than 0 as a result of step 913, the node proceeds to step 919.

The node transmits a queue packet of one stream, and proceeds to step 631 (or step 745) (step 919).

Meanwhile, if it is determined that there exists a retransmission packet and the retransmission flag (ReTx) is 1 as a result of step 911, the node proceeds to step 915.

The node performs a network coding on the retransmission packet and the packet to be transmitted in an opposite direction, and proceeds to step 613 (or step 745) (step 915).

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A packet transmitting method in a low power wireless network, the method comprising:
receiving, by a node, packets from nodes on both sides of the node;
performing a network coding on the received packets; and
transmitting the network coded packets to the nodes on both sides of the node.

2. The method according to claim 1,
further comprising storing, by the node, the packets transmitted to the nodes on both sides of the node.

3. The method according to claim 2,
wherein the performing a network coding comprises:
receiving an ACK packet for checking a nonreceived packet from one of the nodes on both sides of the node; and
network coding a packet corresponding to the nonreceived packet of among the stored packets, and the ACK packet.

4. The method according to claim 3,
wherein the network coding is performed when repeatedly receiving the ACK packet.

5. The method according to claim 1,
further comprising, after the receiving of packets, enqueuing a packet of an upstream direction in an upstream queue, and enqueuing a packet of a downstream direction in a downstream queue, according to a transmission direction of the packet.

6. The method according to claim 5,
wherein each of the upstream queue and the downstream queue comprises a first queue where packets to be transmitted are stored, a second queue where packets that have been transmitted are stored, and a third queue where on-hold packets for retransmission are stored.

7. The method according to claim 6,
wherein the node transmits the received packet to the first queue, second queue, and third queue, successively.

8. The method according to claim 6,
wherein the upstream queue represents the direction of data flow from a border router to a node, and the downstream queue represents the direction of data flow from the node to the border router, in the low power wireless network.

9. The method according to claim 1,
wherein the packet is a TCP (Transmission Control Protocol) packet.

10. The method according to claim 1,
further comprising driving a forward timer for on-holding the packet transmission for a predetermined on-hold time if there does not exist a packet for a network coding.

11. The method according to claim 10,
wherein the on-hold time is the same or longer than a delayed ACK time of the TCP (Transmission Control Protocol).

12. The method according to claim 10,
wherein the on-hold time is predetermined considering an RTT (Round Trip Time) of the packet and the number of hops between E2E nodes.
